(19) United States
(12) Patent Application Publication
(10) Pub. No.: US 2011/0110430 A1
(43) Pub. Date: May 12, 2011

(54) METHOD FOR MOTION ESTIMATION IN MULTIMEDIA IMAGES

(75) Inventors: JIUN-IN GUO, CHIAYI COUNTY (TW); CHING-LUNG SU, CHIAYI COUNTY (TW); CHANG-HUNG TSAI, CHIAYI COUNTY (TW); HSIN-YI LI, CHIAYI COUNTY (TW)

(73) Assignee: NATIONAL CHUNG CHENG UNIVERSITY, CHIAYI COUNTY (TW)

(21) Appl. No.: 12/908,124

(22) Filed: Oct. 20, 2010

(30) Foreign Application Priority Data
Nov. 12, 2009 (TW) 098138386

(51) Int. Cl. H04N 7/26

(52) U.S. Cl. 375/240.16; 375/E07.125

(57) ABSTRACT

The present invention relates to a method for motion estimation in multimedia images, which comprises steps of: dividing a predict image frame into a plurality of groups of macroblocks, and each of the groups of macroblocks including a plurality of macroblocks; predicting a motion vector of each of the groups of macroblocks, and producing a predict motion vector; producing one or more search windows according to the predict motion vector; and comparing a plurality of pixels in each macroblock of each group of macroblocks to a plurality of pixels in the search window, and producing an actual motion vector, respectively. Thereby, by gathering a plurality of macroblocks, a shared predict motion vector is produced for reducing computations in coding. Hence, the coding efficiency can be enhanced.

### FIELD OF THE INVENTION

The present invention relates to a method for motion estimation in images, and particularly to a method for motion estimation in multimedia images.

### BACKGROUND OF THE INVENTION

In image coding, motion prediction is mainly achieved by two different methods. One method adopts the architecture of using the origin as the center of search window. This architecture has much regularity in accessing reference data, and hence facilitating data reuse. However, this architecture needs a greater search region for achieving accurate motion prediction. In particular, when motions in a video are greater or irregular, the increase in search region is significant, thus increasing amount in computations. The other method adopts the architecture of using a predict motion vector as the center of search window. The search region according this architecture is substantially reduced, by approximately 75%, in comparison with the previous architecture. Thereby, the number of computations is roughly 6.25% of the previous one. However, because of using the predict motion vector as the center of search window, it is not sure if the search windows of two adjacent macroblocks can be reused. Thereby, it is necessary to read the search window of each macroblock from the external memory, increasing the frequency of data access and significantly increasing bandwidth requirement to the memory.

Besides, for smaller frames such as QCIF and CIF, the differences in the performance between the architectures described above are not obvious. Nevertheless, when the resolution increases, for example, for D1, HD720, Full HD1080, or even QFHD, the differences in characteristics between the architectures described above are outstanding. By adopting the first architecture, motion prediction will occupy a great amount of coding time. However, because data can be reused efficiently, the bandwidth requirement to the external memory can be reduced effectively. On the other hand, by adopting the second architecture, because the required search region is reduced substantially, the time for motion prediction is reduced significantly. However, because the data of adjacent macroblocks cannot be shared, frequent data access to the external memory requires substantial increase in bandwidth.

Accordingly, the present invention provides a novel method for motion estimation in multimedia images. According to the present invention, not only the drawbacks in algorithm as described above can be avoided, but also the advantages of the two architectures described can be combined. Thereby, the problems mentioned above can be solved.

### SUMMARY

An objective of the present invention is to provide a method for motion estimation in multimedia images, which gathers a plurality of macroblocks and shares a predict motion vector for reducing computations in coding. Hence, the coding efficiency can be enhanced.

Another objective of the present invention is to provide a method for motion estimation in multimedia images, which combines the advantages of using the origin and of using the predict vector as the center of search window via the architecture of the degree of update frequency for achieving the purpose of shrinking search region while maintaining excellent data sharing.

Still another objective of the present invention is to provide a method for motion estimation in multimedia images, which changes search region dynamically and automatically according to the motion characteristics of a video while coding the video, and thus reducing memory demand effectively.

The method for motion estimation in multimedia images comprises steps of: dividing a predict image frame into a plurality of groups of macroblocks, and each of the groups of macroblocks including a plurality of macroblocks; predicting a motion vector of each of the groups of macroblock, and producing a predict motion vector; producing one or more search windows according to the predict motion vector; and comparing a plurality of pixels in each macroblock of each group of macroblocks to a plurality of pixels in the search window, and producing an actual motion vector, respectively. Thereby, by gathering a plurality of macroblocks, a shared predict motion vector is produced for reducing computations in coding. Hence, the coding efficiency can be enhanced.

In addition, the method for motion estimation in multimedia images according to the present invention further comprises steps of: producing an update window located in the search window; and judging if to reuse the predict motion vector while predicting the corresponding motion vector of the next group of macroblock according to whether the actual motion vector of the macroblock falls into the update window. Thereby, the present invention combines the advantages of using the origin and of using the predict vector as the center of search window via the architecture of the degree of update frequency for achieving the purpose of shrinking search region while maintaining excellent data sharing.

Furthermore, after the step of producing the update window, the method for motion estimation in multimedia images according to the present invention further determines the region of the search window of the next predict image frame according to the ratio of the actual motion vectors of the plurality of groups of macroblocks of the predict image frame falling into the update window. Thereby, the present invention changes search region dynamically and automatically according to the motion characteristics of a video while coding the video, and thus reducing memory demand effectively.

### BRIEF DESCRIPTION OF THE DRAWINGS

FIG. 1 shows a flowchart according to a preferred embodiment of the present invention;

FIG. 2 shows an action schematic diagram of the steps in FIG. 1 according to a preferred embodiment of the present invention;

FIG. 3 shows an action schematic diagram of the steps in FIG. 1 according to another preferred embodiment of the present invention;

FIG. 4 shows an action schematic diagram of the steps in FIG. 1 according to another preferred embodiment of the present invention;

FIG. 5 shows a flowchart according to another preferred embodiment of the present invention;

FIG. 6A shows an action schematic diagram of the steps in FIG. 5 according to another preferred embodiment of the present invention;

FIG. 6B shows an action schematic diagram of the steps in FIG. 5 according to another preferred embodiment of the present invention;

FIG. 7 shows an action schematic diagram of the steps in FIG. 5 according to another preferred embodiment of the present invention;

FIG. 8 shows an action schematic diagram of the steps in FIG. 5 according to another preferred embodiment of the present invention; and

FIG. 9 shows a block diagram according to a preferred embodiment of the present invention.

### DETAILED DESCRIPTION

In order to make the structure and characteristics as well as the effectiveness of the present invention to be further understood and recognized, the detailed description of the present invention is provided as follows along with embodiments and accompanying figures.

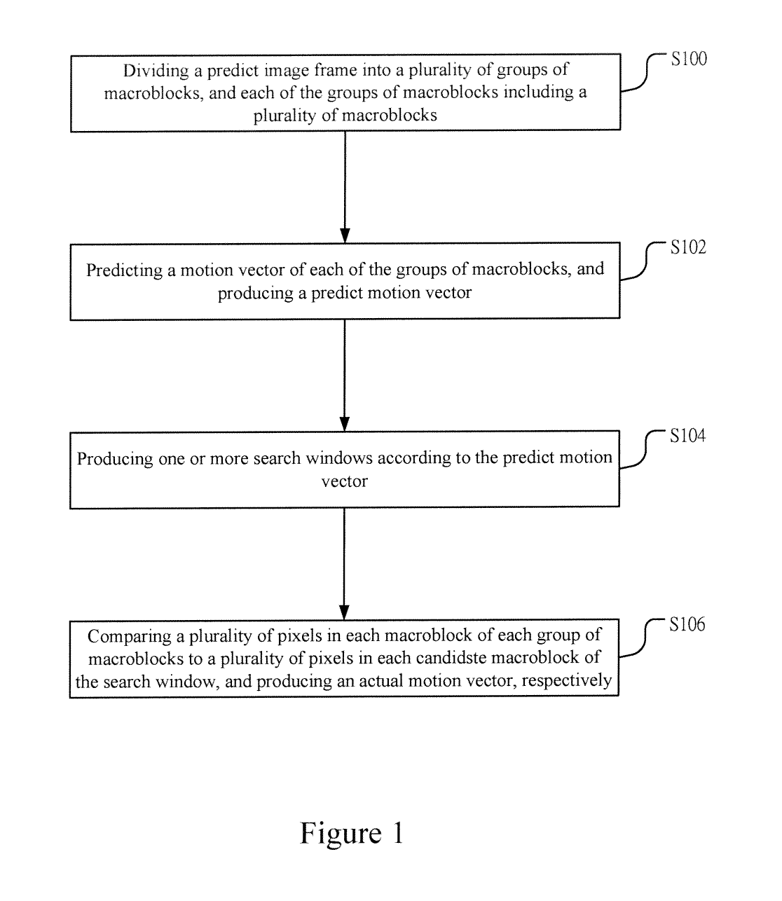

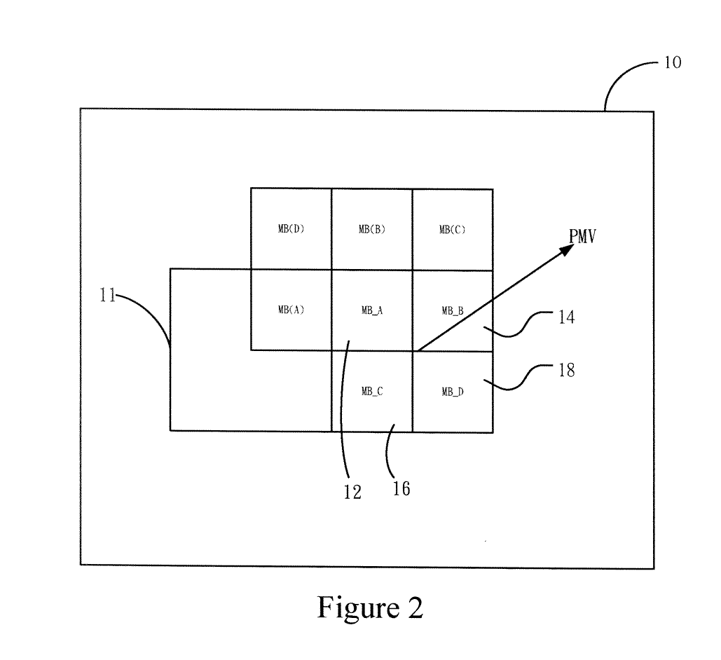

FIG. 1 shows a flowchart according to a preferred embodiment of the present invention; and FIG. 2 shows an action schematic diagram of the steps in FIG. 1 according to a preferred embodiment of the present invention. As shown in the figures, the method for motion estimation in multimedia images according to the present invention first executes the step S100 for dividing a predict image frame 10 into a plurality of groups of macroblocks, and each of the groups of macroblocks including a plurality of macroblocks. Namely, the predict image frame 10 is divided into a plurality of non-overlapping macroblocks (MB). Then a part of the plurality of macroblocks is gathered to form groups of macroblocks. Each of the groups of macroblocks includes a plurality of macro groups. According the present preferred embodiment, four macroblocks MB form a group of macroblocks GOMB. In other words, a first macroblock 12, a second macroblock 14, a third macroblocks 16, and a fourth macroblock 18 form a group of macroblock GOMB. This is only a preferred embodiment of the present invention. Different numbers of the macroblocks MB can be selected to form a group of macroblocks GOMB.

Next, the step S102 is executed for predicting a motion vector (MV) of each of the groups of macroblocks, and producing a predict motion vector (PMV). That is, the motion vector of one macroblock MB of the plurality of macroblocks MB in the group of macroblocks GOMB is predicted, and thus the predict motion vector PMV is produced. As shown in FIG. 2, calculate the predict macro vectors PMV of the first, second, third, and fourth macroblocks 12, 14, 16, 18, and use one of the predict motion vectors as the predict motion vector PMV of the group of motion blocks GOMB, namely, as the predict motion vector PMV of the other macroblocks. In addition, the first, second, third, and fourth macroblocks 12, 14, 16, 18 use the same predict macro vector PMV. The differences are only the offsets in predict motion vectors PMV among them. According to the present preferred embodiment, the motion vector MV of the first macroblock 12 of the group of macroblocks GOMB is predicted for producing the predict motion vector PMV, which is used as the predict motion vector PMV of the group of macroblocks GOMB. This is only a preferred embodiment of the present invention, not used to limit the scope of the present invention.

Besides, regarding to how to predict the motion vector MV of the first macroblock 12 of the group of macroblocks GOMB for producing the predict motion vector PMV, the present invention provides a method for producing the predict motion vector PMV. As shown in FIG. 2, according to the motion vectors MV of the plurality of macroblocks MB adjacent to the first macroblock 12, the predict motion vector PMV is produced. Namely, the motion vectors MV of the plurality of nearby coded macroblocks are used as references. The first macroblock 12 is the current block. The macroblocks MB(A), MB(B), MB(C), and MB(D) are the nearby coded blocks located at the left, top, top right, and top left sides of the first macroblock 12. Then, take the median of the motion vectors of the macroblocks MB(A), MB(B), MB(C), and MB(D) to give the predict motion vector PMV.

However, if any of the motion vectors of the macroblocks MB(A), MB(B), MB(C), and MB(D) does not exist, such as the boundaries of a frame, the system will process as follows: (1) If the motion vectors MV of the macroblocks MB(A) and MB(D) do not exist, the system will preset them as zero. (2) If the motion vectors MV of the macroblocks MB(B), MB(C), and MB(D) do not exist, the system will use the motion vector MV of the macroblock MB(A) as the predict motion vector PMV. (3) If the motion vector MV of the macroblock MB(C) does not exist, the system will replace the macroblock MB(C) by the macroblock MB(D). This is only a preferred embodiment of the present invention, not used to limit the scope of the present invention.

Afterwards, the step S104 is executed for producing one or more search windows SW of a reference image frame (not shown in the figure) according to the predict motion vector PMV. Then, the step S106 is executed for comparing a plurality of pixels in each macroblock MB of each group of macroblock GOMB to a plurality of pixels in each candidate MB of the search window SW, and producing an actual motion vector, respectively. Thereby, by gathering the plurality of macroblocks MB, a shared predict motion vector PMV is produced for reducing computations in coding. Hence, the coding efficiency can be enhanced.

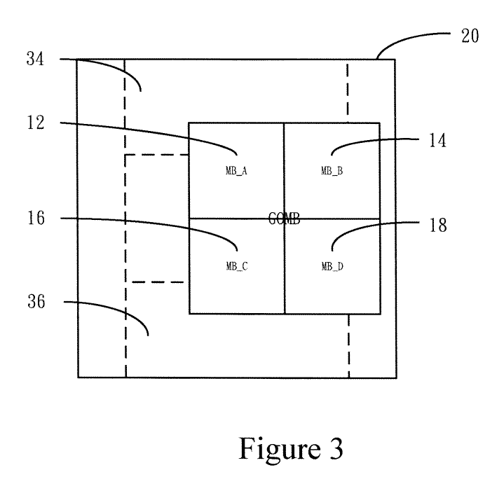

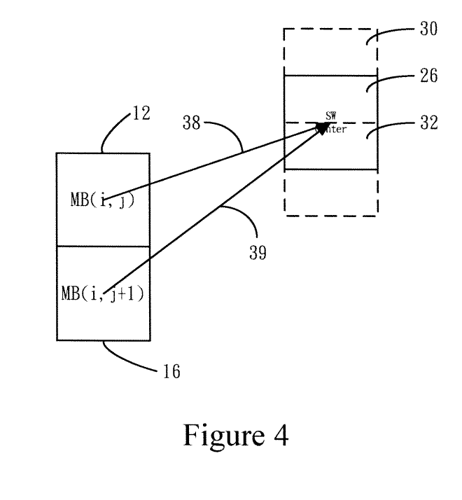

FIG. 3 and FIG. 4 show action schematic diagrams of the steps in FIG. 1 according to another preferred embodiment of the present invention. As shown in the figures, taking a group of macroblocks GOMB as an example, the group of macroblocks GOMB includes a first macroblock 12, a second macroblock 14, a third macroblock 16, and a fourth macroblock 18. The first and the third macroblocks 12, 16 are grouped as a set; and the second and the fourth macroblocks 14, 18 are grouped as another set. The step S104 of producing one or more search windows according to the predict motion vector further comprises forming a shared search window 20 for top/bottom adjacent macroblocks 12, 16 of the plurality of macroblocks MB, and adjusting the region of the shared search window 20, so that the region covers the search windows SW of the top/bottom adjacent first and third macroblocks 12, 16. As shown in FIG. 4, according to the prior art, the first and third macroblocks 12, 16 produce a first search-window center 30 and a second search-window center 32 according to the predict macro vectors PMV, respectively. Then, according to the first and second search-window centers 30, 32, a first search window 34 and a second search window 36 are produced. This method makes the first and second search windows 34, 36 of the first and third macroblocks 12, 16 unable to share to each other, and hence deteriorating coding efficiency.

Owing to the drawback described above, the present invention produces a shared search-window center 26 (as shown in FIG. 4) according to the predict motion vector PMV for the top/bottom adjacent first and third macroblocks 12, 14, and expands the region of the shared search window to produce the shared search window 20. That is, the first and third macroblocks 12, 16 adjust the two predict motion vectors 38, 39 to the shared search-window center 26 according to the predict motion vector 30 calculated previously. Then the region of the shared search window is expanded to produce the shared search-window 20, whose region covers the search windows 34, 36 of the first and third macroblocks 12, 16. By expanding the shared search window 20, the region of motion prediction is increased, and hence the quality of coded images is enhanced. In addition, because the present invention can be applied to the macroblock-adaptive frame-field coding (MBAFF), the top/bottom adjacent first and third macroblocks 12, 14 can thus completely apply the shared search window 20.

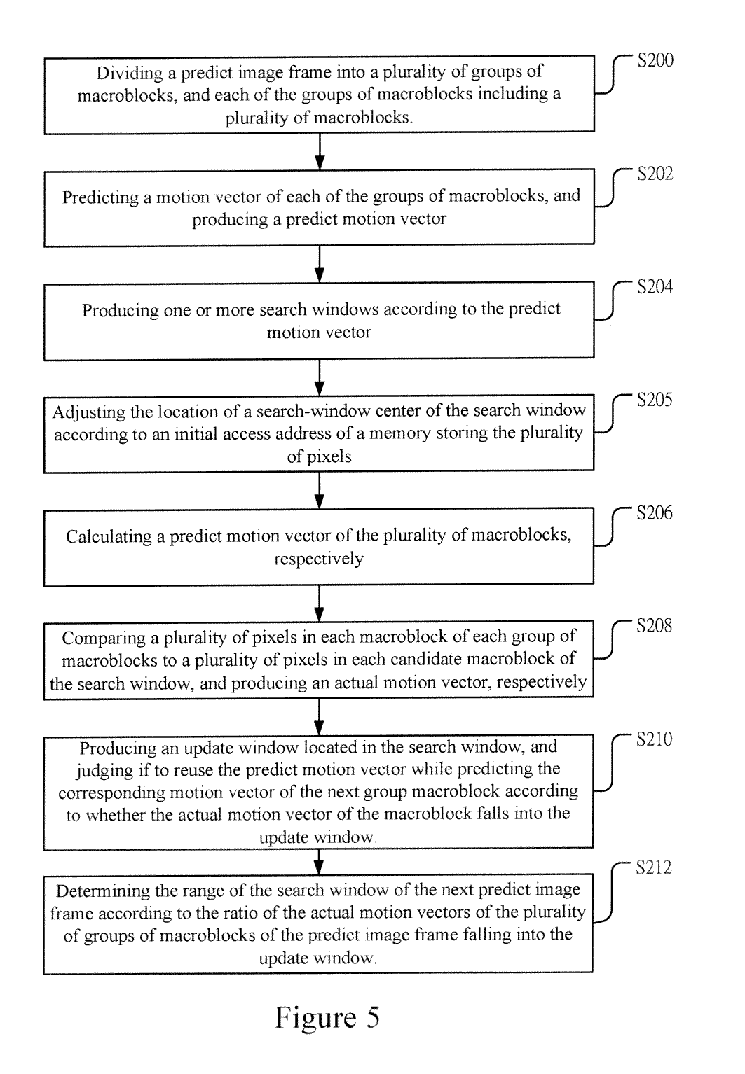

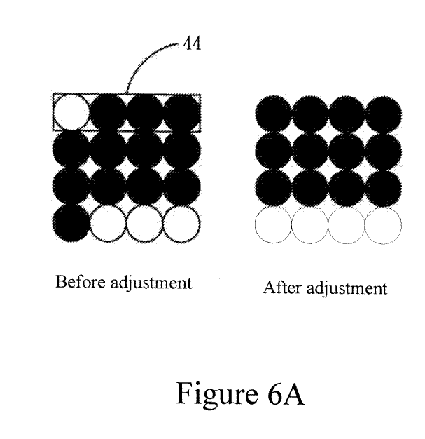

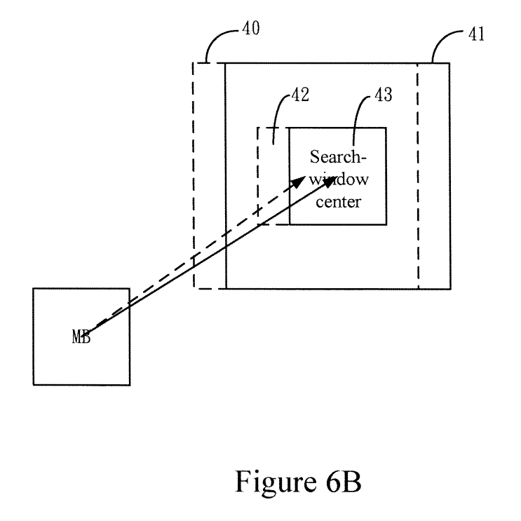

FIG. 5 shows a flowchart according to another preferred embodiment of the present invention. FIGS. 6A and 6B show action schematic diagrams of the steps in FIG. 5 according to another preferred embodiment of the present invention. As shown in the figures, the difference between the present preferred embodiment and the one in FIG. 1 is that, according to the present preferred embodiment, the step S204 of producing one or more search windows SW according to the predict motion vector PMV includes the step S205 for adjusting the location of a search-window center 42 of the search window 40 according to an initial access address of a memory storing the plurality of pixels. The data of the search window 40 are stored in the memory and accessed via the bus. The amount of data read at a time depends on the width of the bus, and the initial access address is an integer multiple. Thereby, if the search window 40 does not adjust according to the width of the bus, the read data will contain invalid data. As shown in FIGS. 6A and 6B, if the width of the bus 44 is 32 bits and 8 bits are required to represent a pixel, the bus 44 will read the data of 4 pixels from the memory at a time. According to the present preferred embodiment, the address at which the pixel data stored is a multiple of 4, thereby the initial access address of the memory is also a multiple of 4. As shown in FIG. 6, when the bus 44 needs to read 12 pixel data in a general architecture, if the first pixel data of the 12 desired pixel data are not located at the initial access address, it takes 4 times to read the data. In addition, in the 4 accesses, 4 invalid pixel data will be read (white circle in the figure). However, after adjusting the location of the search window 40 for matching the width of the bus 44, it takes only 3 times to read. Consequently, memory access times can be reduced effectively. In the following, an example is used to explain the method for adjusting the location of the search window 40 according to the present invention.

For adjusting the location of the search window 40 according to the present invention, the location of the search-window center is adjusted to the closest initial access address of the memory. Taking the example above, the initial access address of the memory is a multiple of 4, such as the addresses of 4, 8, 12, or 16. If the location of the search-window center 42 is at the address 7, the closest initial address is 8, which represents the search-window center 43 in the figure. Thereby the location of the search window 40 is adjusted to the search window 41 in the figure. On the other hand, if the location of the search-window center 42 is at the address 5, the closest initial address is 4. Thereby the location of the search-window center 42 is adjusted to the initial access address 4. After the adjustments described above, invalid access of pixel data owing to inconformity between the initial access address of the pixel data in the search window 40 and the initial access address of the memory.

Afterwards, according to the method for prediction motion in multimedia images of the present invention, before executing the step S208 of comparing a plurality of pixels in each macroblock MB of each group of macroblocks GOMB to a plurality of pixels in each candidate macroblock MB of the search window SW, and producing an actual motion vector, respectively, the step S206 is first executed for calculating a predict motion vector of the plurality of macroblocks, respectively. After comparing a plurality of pixels in each macroblock of each group of macroblocks to a plurality of pixels in the search window and producing an actual motion vector, the step S206 can calculate and give a difference motion vector (DMV) according to the actual motion vector and the predict motion vector for subsequent circuit calculations. Referring back to FIG. 2, in pipeline hardware architecture, because the calculations for the previous group of macroblocks in the pipeline is possibly not finished, its data cannot be accessed and used. According to the present architecture, the predict motion vector is changed and the reference motion vector with least loss is calculated, the pipeline scheduling problem can be solved without sacrificing image quality. That is to say, in the pipeline scheduling, if the macroblock MB(A) has not stored the motion vector to the memory, the motion vectors of MB(B), MB(C), and MB(D) can be used for calculation the predict motion vector.

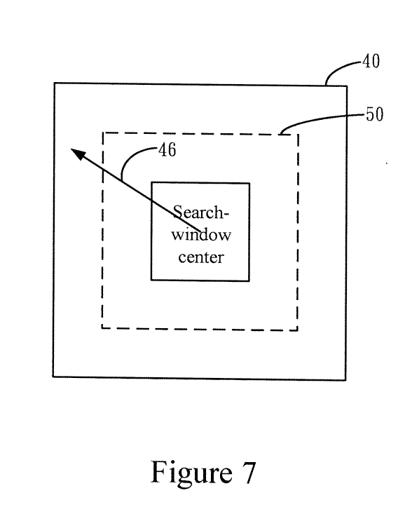

Refer back to FIG. 5 and FIG. 7, which shows an action schematic diagram of the steps in FIG. 5 according to another preferred embodiment of the present invention. As shown in the figures, next, the step S210 is executed for producing an update window 50 located in the search window 40, and judging if to reuse the predict motion vector PMV while predicting the corresponding motion vector of the next group of macroblock according to whether the actual motion vector 46 of the macroblock MB falls into the update window 50. Thereby, the purposes of reusing data and reducing data access can be achieved. Accordingly, architecture of motion prediction with low complexity, low computations, and low power consumption can be attained.

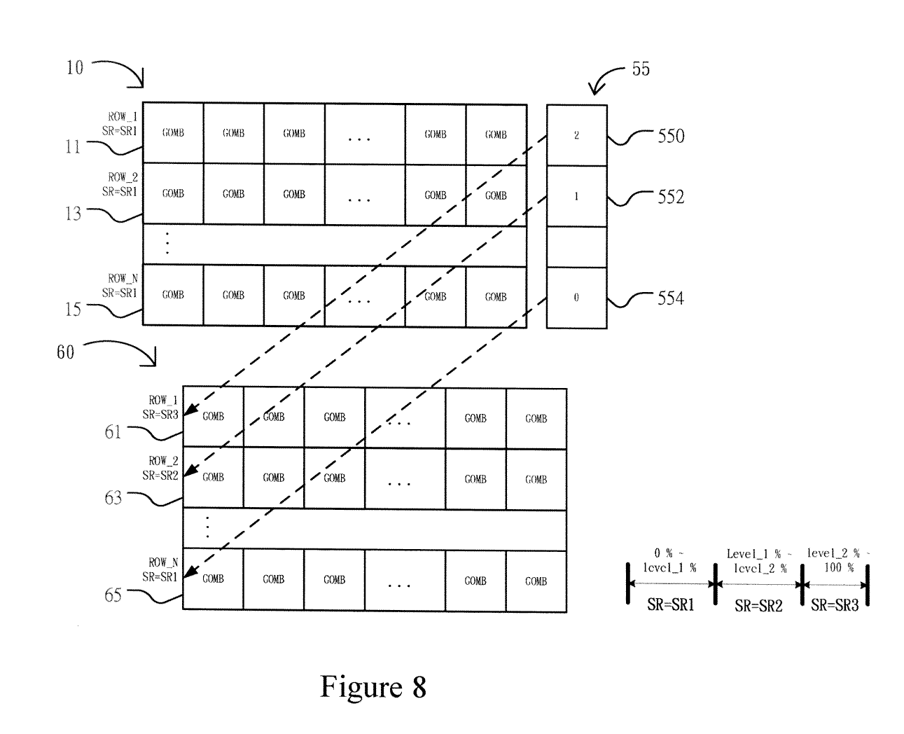

FIG. 8 shows an action schematic diagram of the steps in FIG. 5 according to another preferred embodiment of the present invention. As shown in the figure, the step S212 is executed for determining the region of the search window of the next predict image frame according to the ratio of the actual motion vectors 46 of the plurality of groups of macroblocks of the predict image frame 10 falling into the update window 40. The region of the search window of the next predict image frame 60 is determined according to the ratio of the actual motion vectors 46 of each row of the plurality of groups of macroblocks GOMB of the predict image frame 10 falling into the update window 40.

According to the present preferred embodiment, the ratio of actual motion vectors 46 falling into the update window 40 is divided to a first ratio 0%˜level_{—}1%, a second ratio level_{—}1%˜level_{—}2%, and a third ratio level_{—}2%˜100%, which correspond to a first search-window region SR1, a second search-window region SR2, and a third search-window region SR3, respectively. When the ratio of the actual motion vectors 46 of each row of the plurality of groups of macroblocks GOMB falling into the update window 40 is the first ratio 0%˜level_{—}1%, the second ratio level_{—}1%˜level_{—}2%, or the third ratio level_{—}2%˜100%, the region of the search window is adjusted to the corresponding first search-window region SR1, the second search-window region SR2, or the third search-window region SR3. Thereby, the present invention changes search region dynamically and automatically according to the motion characteristics of a video while coding the video, and thus reducing memory demand effectively.

Furthermore, the present invention includes a memory 55 for storing the corresponding search-window regions SR1, SR2, or SR3 of each row of the plurality of groups of macroblocks GOMB of the next predict image frame 60. The search-window regions SR1, SR2, or SR3 stored in the memory 55 is determined according to the ratio of the actual motion vectors 46 of each row of the plurality of groups of macroblocks GOMB of the predict image frame 10 falling into the update window 40.

The memory 55 comprises a plurality of storage locations 550, 552, 554, which correspond to each row of the plurality of groups of macroblocks 11, 13, 15, respectively. Namely, a first-row group of macroblocks 11, a second-row group of macroblocks 13, to a Nth-row group of macroblocks 15 correspond to a first storage location 550, a second storage location 552, to a Nth storage location 554, respectively, which further correspond to each row of the plurality of groups of macroblocks GOMB of the next predict image frame 60, respectively. In other word, the first, second, to the Nth storage locations 550, 552, 554 correspond to groups of macroblocks of the first row 61, groups of macroblocks of the second row 63, to groups of macroblocks of the Nth row 65, respectively.

The first, second, and third search-window regions SR1, SR2, SR3 corresponding to the first ratio 0%˜level_{—}1%, the second ratio level_{—}1%˜level_{—}2%, and the third ratio level_{—}2%˜100% are stored in the first, second, to the Nth storage locations 550, 552, 554, respectively. Then, the groups of macroblocks of the first row 61, the groups of macroblocks of the second row 63, to the groups of macroblocks of the Nth row 65 of the next predict image frame 60 correspond to the first, second, and third search-window regions SR1, SR2, SR3 of the first, second, to the Nth storage locations 550, 552, 554, respectively, no that the region of the search window can be adjusted accordingly.

For example, when the ratio of the plurality of actual motion vectors 46 of the groups of macroblocks of the first row 11 of the predict image frame 10 falling into the update window 40 is the third ratio level_{—}2%˜100%, the first storage location 550 of the memory 55 stores the third search-window region SR3 correspondingly. Thereby, when the groups of macroblocks of the first row 61 of the next predict image frame 60 perform searches, the third search-window region SR3 in the first storage location 550 will be read as the search-window region of the groups of the macroblocks of the first row 61 and the search window will thus be produced. Accordingly, the search-window region of the groups of macroblocks of the first row 61 of the predict image frame 10 differs from the search-window region of the groups of macroblocks of the first row 61 of the next predict image frame 60. Thereby, the present invention can change search region dynamically and automatically according to the motion characteristics of a video while coding the video, and thus reducing memory demand effectively. According to the present preferred embodiment, the second and Nth storage locations 552, 554 of the memory 55 store the second and first search-window regions SR2, SR1, respectively. Hence, search-window regions of the groups of macroblocks of the second row 63 and of the Nth row 65 are the second search-window region SR2 and the first search-window region SR1, respectively.

According to the description above, each row of the plurality of groups of macroblocks GOMB of the predict image frame 10 corresponds to the plurality of groups of macroblocks of the same row for the next predict image frame 60, respectively. Besides, the region of the search window of each row of the plurality of groups of macroblocks GOMB for the next predict image frame 60 is determined according to the ratio of the actual motion vectors of the plurality of groups of macroblocks GOMB of the same row for the predict image frame 10 falling into the update window 40.

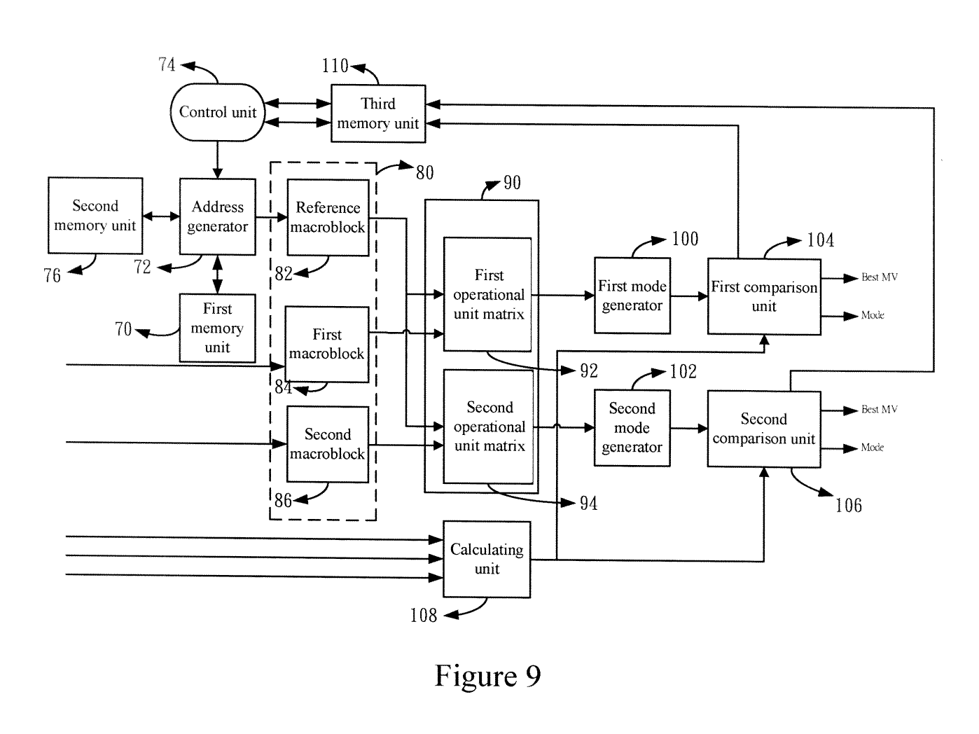

FIG. 9 shows a block diagram according to a preferred embodiment of the present invention. As shown in the figure, the block diagram for motion estimation in multimedia images according to the present invention comprises a first memory unit 70, an address generator 72, a control unit 74, a second memory unit 76, a memory module 80, an operational module 90, a first mode generator 100, a second mode generator 102, a first comparison unit 104, a second comparison unit 106, a rate distortion cost calculating unit 108, and a third memory unit 110. The first memory unit 70 is used for storing a plurality of reference pixel data of the previous image frame, namely, the reference image frame. The first memory unit 70 is an external memory. The address generator 72 is coupled to the first memory unit 70 for accessing the plurality of reference pixel data in the first memory unit 70 according to an address command of the control unit 74. The control unit 74 controls the address generator 72 to read the reference pixel data in the first memory unit 70 according to the region and location of the search window, and transmits the reference pixel data to the second memory unit 76. Thereby, the reference pixel data stored in the second memory unit 76 are the reference pixel data in the search window.

The memory module 80 stores a reference macroblock 82, a first macroblock 84, and a second macroblock 86. The control unit 74 reads the reference pixel data of the second memory unit 76 via the address generator 72 and stores it to the memory module 80 as the reference macroblock 82. The first and second macroblocks 84, 86 are the pixel data in the macroblock of the current predict image frame. In addition, the first and second macroblocks 84, 86 are top/bottom adjacent macroblocks. The operational module 90 includes a first operational unit matrix 92 and a second operational unit matrix 94. The first operational unit matrix 92 receives the reference pixel data of the reference macroblock 82 and the pixel data of the first macroblock 84 for calculating and giving a first sum of absolute difference (SAD). Likewise, the second operational unit matrix 94 receives the reference pixel data of the reference macroblock 82 and the pixel data of the second macroblock 86 for calculating and giving a second sum of absolute difference.

After the first mode generator 100 receives the first sum of absolute difference, the first mode generator 100 perform 7 modes of combination. Taking a 16×16 reference macroblock as example, because the throughput of the pixel data processed by the first and second operational unit matrixes 92, 94 is limited, only part of the pixel data can be processed at a time. According to the present preferred embodiment, the handleable pixel data at a time is 4×4. After the first and second operational unit matrixes 92, 94 process the 4×4 pixel data, the first model generator 100 perform 7 modes of combination for rebuilding the 16×16 macroblock, producing a corresponding 16×16 first sum of absolute difference, and transmitting the first sum of absolute difference to the first comparison unit 104. Likewise, the second mode generator 102 produces a 16×16 second sum of absolute difference and transmits it to the second comparison unit 106.

The rate distortion cost calculating unit 108 receives a motion vector, a reference signal (λ factor), and a predict motion vector for producing a rate-distortion-cost signal. The first comparison unit 104 gives a best motion vector of the first macroblock 84 and the mode corresponding to the best motion vector according to the rate-distortion-cost signal and the first sum of absolute difference for subsequent operations performed by the coding circuit. Likewise, the second comparison unit 106 gives the best motion vector the second macroblock 86 and the mode corresponding to the best motion vector according to the rate-distortion-cost signal and the second sum of absolute difference for subsequent operations performed by the coding circuit. The first operational unit matrix 92, the second operational unit matrix 94, the first mode generator 100, the second mode generator 102, the first comparison unit 104, the second comparison unit 106, and the rate distortion cost calculating unit 108 described above are presently available technologies, and hence will not be explained in detail.

Besides, the best motion vectors of the first and second macroblocks 84, 86 are transmitted to the third memory unit 110. The control unit 74 acquires the best motion vectors of the first and second macroblocks 84, 86 by accessing the third memory unit 110. Then the control unit 74 performs the method for motion estimation in multimedia images according to the present invention for changing the searching region dynamically and for judging if to reuse the predict motion vector PMV while predicting the corresponding motion vector of the next group of macroblocks. Thereby, the amount of computations can be reduced.

Moreover, according to the present invention, because the top/bottom adjacent macroblocks can use the same search window, the operational module 90 in circuit contains both of the first and second operation unit matrixes 92, 94 for calculating the pixel data of two macroblocks simultaneously. Hence, the operation efficiency can be enhanced.

To sum up, the method for motion estimation in multimedia images according to the present invention comprises steps of: dividing a predict image frame into a plurality of groups of macroblocks, and each of the groups of macroblocks including a plurality of macroblocks; predicting a motion vector of each of the groups of macroblocks, and producing a predict motion vector; producing one or more search windows according to the predict motion vector; and comparing a plurality of pixels in each macroblock of each group of macroblocks to a plurality of pixels in the search window, and producing an actual motion vector, respectively. Thereby, by gathering a plurality of macroblocks, a shared predict motion vector is produced for reducing computations in coding. Hence, the coding efficiency can be enhanced.

Accordingly, the present invention conforms to the legal requirements owing to its novelty, nonobviousness, and utility. However, the foregoing description is only embodiments of the present invention, not used to limit the scope and range of the present invention. Those equivalent changes or modifications made according to the shape, structure, feature, or spirit described in the claims of the present invention are included in the appended claims of the present invention.

1. A method for motion estimation in multimedia images, comprising steps of:
dividing a predict image frame into a plurality of groups of macroblocks, and each of said groups of macroblocks including a plurality of macroblocks;
predicting a motion vector of each of said groups of macroblocks, and producing a predict motion vector;
producing one or more search windows according to said predict motion vector; and
comparing a plurality of pixels in each macroblock of each group of macroblocks to a plurality of pixels in said search windows, and producing an actual motion vector, respectively.

2. The method for motion estimation in multimedia images of claim 1, wherein said step of predicting said motion vector of each of said groups of macroblocks and producing said predict motion vector is predicting said motion vector of one of said macroblocks of said plurality of macroblocks in each of said groups of macroblocks and producing said predict motion vector.

3. The method for motion estimation in multimedia images of claim 2, wherein the step of predicting said motion vector of one of said macroblocks of said plurality of macroblocks in each of said groups of macroblocks and producing said predict motion vector is predicting said motion vector of a first macroblock of said macroblocks of said plurality of macroblocks in each of said groups of macroblocks and producing said predict motion vector.

4. The method for motion estimation in multimedia images of claim 3, wherein the step of predicting said motion vector of a first macroblock of said macroblocks of said plurality of macroblocks in each of said groups of macroblocks and producing said predict motion vector further comprises producing said predict motion vector according to a plurality of motion vectors of said plurality of macroblocks adjacent to said first macroblock.

5. The method for motion estimation in multimedia images of claim 1, wherein said step of producing one or more search windows according to said predict motion vector further comprises steps of:
forming a shared search window for the top/bottom adjacent macroblocks of said plurality of macroblocks; and
adjusting the region of said shared search window, so that the region of said shared search window covers the search windows of said top/bottom adjacent macroblocks.

6. The method for motion estimation in multimedia images of claim 5, wherein said step of forming said shared search window for the top/bottom adjacent macroblocks of said plurality of macroblocks is producing a shared search-window center according to a plurality of search-window centers of said plurality of corresponding search windows of said plurality of top/bottom adjacent macroblocks; expanding the region of said shared search window; and producing said shared search window.

7. The method for motion estimation in multimedia images of claim 1, and further comprising steps of:
producing an update window located in said search window; and
judging if to reuse said predict motion vector while predicting the corresponding motion vector of the next group of macroblock according to whether said actual motion vector of the macroblock falls into said update window.

8. The method for motion estimation in multimedia images of claim 7, and further comprising a step of determining the region of said search window of the next predict image frame according to the ratio of said actual motion vectors of said plurality of groups of macroblocks of said predict image frame falling into said update window.

9. The method for motion estimation in multimedia images of claim 1, wherein said step of producing one or more search windows according to said predict motion vector further comprises adjusting the location of a search-window center of said search window according to an initial access address of a memory storing said plurality of pixels.

10. The method for motion estimation in multimedia images of claim 1, and further comprising a step of a predict motion vector of said plurality of macroblocks before said step of comparing said plurality of pixels in each macroblock of each group of macroblocks to said plurality of pixels in said search windows and producing said actual motion vector, respectively.

11. The method for motion estimation in multimedia images of claim 1, and applied to the macroblock-adaptive frame-field coding.
